(19) United States
(12) Patent Application Publication
(10) Pub. No.: US 2018/0056729 A1
(43) Pub. Date: Mar. 1, 2018

(54) TIRE GROOVE

(71) Applicant: THE GOODYEAR TIRE & RUBBER COMPANY, Akron, OH (US)

(72) Inventors: Austin Gale YOUNG, Wadsworth, OH (US); Robert John HERMANN, Cuyahoga Falls, OH (US)

(21) Appl. No.: 15/253,983

(22) Filed: Sep. 1, 2016

Related U.S. Application Data
(60) Provisional application No. 62/380,571, filed on Aug. 29, 2016.

(51) Int. Cl. B60C 11/13

(52) U.S. Cl. CPC B60C 11/13; B60C 11/1323

(57) ABSTRACT

A tire includes a tread portion having at least one circumferential main groove extending in a circumferential direction of the tire and spaced axially apart from an equator of the tire. The groove has a circumferential profile shape including an inner wall portion extending radially inward from an axially inner edge of the groove, an inner arc portion continuous with the inner wall portion and having a smaller radius of curvature than the inner wall portion, an outer wall portion extending radially inward from an axially outer edge of the groove and having a larger length than the inner wall portion, an outer arc portion continuous with the outer wall portion and having a smaller radius of curvature than the outer wall portion, and a groove bottom portion extending straight from the outer arc portion toward the inner arc portion while being inclined in a radially inward direction whereby the groove bottom portion has a constant radius of curvature.

### FIELD OF INVENTION

The present invention relates to a tire and, more particularly, to a tire including a tread groove with a cross sectional shape specified to reduce generation of cracks in the vicinity of the groove bottom.

### BACKGROUND OF THE INVENTION

In a conventional tread portion of a pneumatic tire, a tensile strain generates shrinkage of rubber in the groove bottom due to temperature reduction after vulcanization. Such a strain may cause cracking at the groove bottom. Particularly, cracking may occur at arc-like corner portions between the groove bottom and groove walls, since the tensile strain largely acts on the corner portions of the groove. Rubber shrinkage and cracking may also occur at arc-like corner portions located on a shoulder of the tread.

In order to conventionally suppress such cracking, a rubber with a high degree of swelling in the tread portion has been used. However, rubber with a high degree of swelling may degrade rolling resistance and steering stability of the pneumatic tire, since rubber hardness may decrease. Grooves with various cross sectional shapes have been conventionally used to mitigate the cracking.

### SUMMARY OF THE INVENTION

A tire in accordance with the present invention includes a tread portion having at least one circumferential main groove extending in a circumferential direction of the tire and spaced axially apart from an equator of the tire. The groove has a circumferential profile shape including an inner wall portion extending radially inward from an axially inner edge of the groove, an inner arc portion continuous with the inner wall portion and having a smaller radius of curvature than the inner wall portion, an outer wall portion extending radially inward from an axially outer edge of the groove and having a larger length than the inner wall portion, an outer arc portion continuous with the outer wall portion and having a smaller radius of curvature than the outer wall portion, and a groove bottom portion extending straight from the outer arc portion toward the inner arc portion while being inclined in a radially inward direction whereby the groove bottom portion has a constant radius of curvature.

According to another aspect of the tire, the groove has an axial tread surface width between 10.0 mm and 20.0 mm.

According to still another aspect of the tire, the groove has an axial tread surface width of 14.84 mm.

According to yet another aspect of the tire, the groove has an upper base radius between 3.0 mm and 8.0 mm.

According to still another aspect of the tire, the groove has an upper base radius of 5.0 mm.

According to yet another aspect of the tire, the groove has a bottom base radii between 1.0 mm and 5.0 mm.

According to still another aspect of the tire, the groove has a bottom base radius of 3.0 mm.

According to yet another aspect of the tire, the groove has two asymmetric draft angles of between 0.0° and 5.0° and 10.0° and 20.0°, respectively.

According to still another aspect of the tire, the groove has a draft angle radially inward of asymmetric draft angles between 10.0° and 20.0°.

According to another aspect of the tire, the groove is located at an axial position apart from the tire equator by a distance of 10.0 to 35.0 percent of an axial tread width.

According to yet another aspect of the tire, the groove has a radius of curvature of the outer arc portion gradually decreasing away from a radially outer tread surface of the tire.

According to still another aspect of the tire, the groove extends at an angle of less than 45° with respect to the circumferential direction of the tire.

### BRIEF DESCRIPTION OF THE DRAWINGS

The structure, operation, and advantages of the present invention will become more apparent upon contemplation of the following description of examples of the present invention taken in conjunction with the accompanying drawings of the examples, wherein:

FIG. 1 is a cross sectional view showing a tread groove in accordance with the present invention.

### DETAILED DESCRIPTION OF EXAMPLES OF THE PRESENT INVENTION

A pneumatic tire may include a carcass extending from a tread portion to each of two bead cores in opposing bead portions through sidewall portions, and a belt layer disposed radially outward of the carcass in the tread portion, as disclosed in US 2012/0042998, incorporated herein by reference in its entirety. The carcass may include at least one carcass ply having a toroidal main portion that extending from one bead core to the opposing bead core and turn up portions extending from both ends of the main portion and turned up around the bead cores from the axially inside to the axially outside of the pneumatic tire to anchor the carcass ply to the bead cores. In the carcass ply, carcass cords (e.g., carcass cords made of an organic fiber) may be disposed at an angle of, for example, 75° to 90° with respect to the tire circumferential direction. Between the ply main portion and each turn up portion may be disposed a bead apex rubber for reinforcement of bead portions extending radially outwardly from the bead cores in a tapered manner.

The belt layer may include at least two plies. The belt plies may include belt cords having a high elasticity (e.g., steel cords). The pneumatic tire may include two belt plies (e.g., a radially inner belt ply and a radially outer belt ply in which the inner ply has a larger width than the outer ply) and steel belt cords arranged at an angle of, for instance, 15° to 40° with respect to the tire circumferential direction. The belt plies may be stacked so that the belt cords in one ply cross cords in the other belt ply.

The tread portion may have at least one circumferential main groove extending continuously in the tire circumferential direction. The tread portion may have four circumferential main grooves extending straight and continuously in the tire circumferential direction on both sides of a tire equator (e.g., a pair of first circumferential main grooves disposed on a tread edge and a pair of second circumferential main grooves disposed axially inward of the first circumferential main grooves whereby on the tread portion are formed a pair of shoulder land portions extending between the first circumferential main groove and a tread edge, a pair of middle land portions extending between the first circumferential main groove and the second circumferential main groove, and a center land portion extending between the second circumferential main grooves). The first and second circumferential main grooves may be disposed symmetrically with respect to the tire equator.

The term “tread edge” as used herein means each of axially outer edges of a ground contact surface of the pneumatic tire contacting a ground (flat surface) when the pneumatic tire, in a standard state, is loaded with a normal load. The term “normal load” means a load defined for every tire in a standardizing system and is, for example, a “maximum load capacity” in JATMA, a maximum value recited in the table of “Tire Load Limits at Various Cold Inflation Pressures” in TRA, and/or “Load Capacity” in ETRTO, provided that in case of tires for passenger cars, the “normal load” is a load of 88% of the load defined above.

The first circumferential main groove may be formed into a straight groove extending straight in the tire circumferential direction. The straight groove may define a shoulder land portion with a constant width. Therefore, since the tensile strain acting on the first main groove may be equalized, cracking may be suppressed. However, the first main groove may not be limited to a straight groove, but may have other configurations (e.g., a zigzag groove in which each zigzag component is inclined at an angle of 45° or 30° with respect to the tire circumferential direction).

The first circumferential main groove may have a profile shape such that, in a meridian cross section including a rotational axis of the tire in a standard state, the profile shape may define an inner wall portion extending radially inward from an axially inner edge on one side of the tire equator and defining a flat wall, or a curved wall having a first radius of curvature, an inner arc portion continuous with the inner wall portion and having a smaller radius of curvature than a second radius of curvature of the inner wall portion, an outer wall portion extending radially inward from an axially outer edge on a tread edge side and having a smaller length than that of the inner wall portion and defining a flat wall or a curved wall having a third radius of curvature, an outer arc portion continuous with the outer wall portion and having a smaller fourth radius of curvature than the third radius of curvature of the outer wall portion, and a groove bottom portion extending straight from the outer arc portion toward the inner arc portion while being inclined in a radially inward direction whereby the main groove has a maximum depth portion on a tire equator side with respect to a center position of its width.

A pneumatic tire with such a circumferential main groove may increase rubber volume to enhance the rigidity near the outer arc portion. The pneumatic tire may thereby counter tensile strain resulting from rubber shrinkage occurring after vulcanization and thus reduce cracks in the vicinity of the outer arc portion and the groove bottom. The pneumatic tire may suppress increases in rolling resistance and deterioration of steering stability.

A “double bottom” groove geometry in accordance with the present invention may allow a larger base radius and/or larger draft angle without increasing the groove width at the tread surface. Limiting the groove width may allow maintenance of wearable rubber volume (removal kilometers) and reduce rib tear from catching an obstruction with the inside surface of an outside rib. Both larger base radius and increase draft angles result in lower stress at the bottom of the groove.

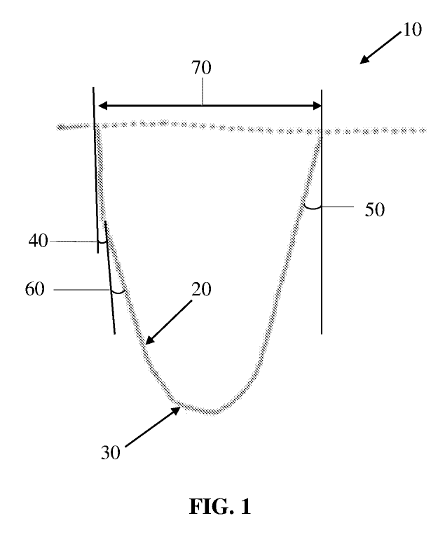

The double bottom groove geometry may allow the use of larger base radius and and/or larger rib edge draft angle by eliminating the requirement that each side of the groove radii be tangent at the bottom of the groove. The upper and lower groove base radii may have a wide range of useable radii. Either may be varied independently to meet specific application requirements and may also be impacted by design nonskid, rib draft angle, and appearance, while still meeting the same objectives of increasing the base radii and/or draft angle without increasing the groove surface width. A lower limit for upper groove radii may be a radii that is tangent at the groove base (full nonskid) with no sub groove being required. An upper limit may be restrained only by groove geometry and appearance. Lower groove radii may be restrained by groove geometry and appearance. The radii and draft angles of FIG. 1 set no constraints on possible combination options of radii and draft angles within the scope of the present invention.

One conventional double bottom groove has used a large base radius and a narrower, deeper subsection of groove bottom with a small base radius. This approach may increase under tread groove gauge (narrow subsurface groove prevents stones from reaching true groove bottom) and may allow larger base radii and larger draft angles in the upper groove profile (reducing the probability of stone holding and reducing probability of base of groove stress cracking). However, the small base radius at the groove bottom of the narrow subsurface groove affected nonskid measurement and visual appearance when approaching wear out.

A double bottom groove geometry in accordance with the present invention may minimize those disadvantages. Both the upper base radii and the bottom base radii may be large radii. As shown in FIG. 1, a double bottom groove 10 of a pneumatic or non-pneumatic tire may have a tread surface width 70 of between 10.0 mm and 20.0 mm, or about 15.0 mm or 14.84 mm, an upper base radii 20 of between 3.0 mm and 8.0 mm, or about 5.0 mm, and a bottom base radii 30 of between 1.0 mm and 5.0 mm, or about 3.0 mm, along with asymmetric draft angles 40, 50 of between 0.0° and 5.0°, or 2.0°, and between 10.0° and 20.0°, or 15.0°, respectively, with a large draft angle 60 of between 10.0° and 20.0°, or about 15.0°, at a base of both sides of the groove 10.

While examples of the present invention have been described with reference to the drawing, the present invention is not limited to only such examples and various changes and modifications may be made. The present invention is more specifically described and explained by means of the following examples and comparative examples. It is to be understood that the present invention is not limited to these examples.

What is claimed:

1. A tire comprising a tread portion having at least one circumferential main groove extending in a circumferential direction of the tire and spaced axially apart from an equator of the tire,
the groove having a circumferential profile shape including an inner wall portion extending radially inward from an axially inner edge of the groove, an inner arc portion continuous with the inner wall portion and having a smaller radius of curvature than the inner wall portion, an outer wall portion extending radially inward from an axially outer edge of the groove and having a larger length than the inner wall portion, an outer arc portion continuous with the outer wall portion and having a smaller radius of curvature than the outer wall portion, and a groove bottom portion extending straight from the outer arc portion toward the inner arc portion while being inclined in a radially inward direction whereby the groove bottom portion has a constant radius of curvature.

2. The tire as set forth in claim 1 wherein the groove has an axial tread surface width between 10.0 mm and 20.0 mm.

3. The tire as set forth in claim 1 wherein the groove has an axial tread surface width of 14.84 mm.

4. The tire as set forth in claim 1 wherein the groove has an upper base radius between 3.0 mm and 8.0 mm.

5. The tire as set forth in claim 1 wherein the groove has an upper base radius of 5.0 mm.

6. The tire as set forth in claim 1 wherein the groove has a bottom base radii between 1.0 mm and 5.0 mm.

7. The tire as set forth in claim 1 wherein the groove has a bottom base radius of 3.0 mm.

8. The tire as set forth in claim 1 wherein the groove has two asymmetric draft angles of between 0.0° and 5.0° and 10.0° and 20.0°, respectively.

9. The tire as set forth in claim 1 wherein the groove has a draft angle radially inward of asymmetric draft angles between 10.0° and 20.0°.

10. The tire as set forth in claim 1 wherein the groove is located at an axial position apart from the tire equator by a distance of 10.0 to 35.0 percent of an axial tread width.

11. The tire as set forth in claim 1 wherein the groove has a radius of curvature of the outer arc portion gradually decreasing away from a radially outer tread surface of the tire.

12. The tire as set forth in claim 1 wherein the groove extends at an angle of less than 45° with respect to the circumferential direction of the tire.
